(19) United States
(12) Patent Application Publication
(10) Pub. No.: US 2026/0301282 A1
(43) Pub. Date: Oct. 1, 2026

(54) METHOD FOR GENERATING RESOLUTION-ENHANCED MEDICAL IMAGING DATA, AND DEVICE

(71) Applicant: GE Precision Healthcare LLC, Waukesha, WI (US)

(72) Inventors: Xueli Wang, Beijing (CN); Bingjie Zhao, Beijing (CN); Xiaokun Huang, Beijing (CN); Ximiao Cao, Beijing (CN)

(21) Appl. No.: 19/578,483

(22) Filed: Mar. 25, 2026

(30) Foreign Application Priority Data
Mar. 25, 2025 (CN) 202510355009.2

(51) Int. Cl. G06T 12/30; G06T 5/50; G06T 5/60; G06T 5/70; G06T 7/49

(52) U.S. Cl. CPC G06T 12/30; G06T 5/50; G06T 5/60; G06T 5/70; G06T 7/49; G06T 2207/10081; G06T 2207/10104; G06T 2207/20081; G06T 2207/20084

(57) ABSTRACT

A method and device for generating resolution-enhanced imaging data, are described. The method includes acquiring a raw three-dimensional projection generated by an imaging system scanning a subject, decomposing the raw three-dimensional projection dataset into a set of sub-datasets including different frequency information, executing texture orientation feature extraction on each sub-dataset in the set of sub-datasets to generate a set of texture orientation feature maps for each sub-dataset, inputting each sub-dataset and the set of texture orientation feature maps into a resolution enhancement neural network to generate a resolution-enhanced sub-dataset of each sub-dataset, wherein the resolution-enhanced sub-dataset has a higher resolution than the corresponding sub-dataset, and synthesizing the resolution-enhanced sub-datasets of all sub-datasets to generate a resolution-enhanced three-dimensional projection dataset corresponding to the raw three-dimensional projection dataset, wherein the resolution-enhanced three-dimensional projection dataset has a higher resolution and is used to reconstruct an image of the subject.

### CROSS-REFERENCE TO RELATED APPLICATIONS

This application claims priority to Chinese Application No. 202510355009.2, filed on Mar. 25, 2025, the disclosure of which is incorporated herein by reference in its entirety.

### TECHNICAL FIELD

The present disclosure relates to the field of image processing, and in particular, to a method for generating resolution-enhanced imaging data, and a device.

### BACKGROUND

Computed tomography (CT) technology plays a vital role in medical diagnosis, and increasing the resolution of a CT image can significantly improve diagnostic accuracy. High-resolution CT images not only help doctors observe lesions more clearly but also increase the detection rate of early-stage diseases, thereby providing patients with more timely treatment. Generally, methods for increasing the resolution of the CT image mainly include two directions: hardware and software.

In terms of hardware, improvement measures include techniques such as using a smaller detector, a smaller focus point, and focus jitter, which can directly increase the resolution of the image. In terms of software, methods for increasing image resolution include increasing a cut-off frequency of a filter, optimizing a data interpolation algorithm, applying a denoising algorithm, enlarging a reconstruction matrix, and the like.

When processing given raw data, how to explore the resolution potential of the raw data has always been an important research topic. In addition to the above software methods, application of deep learning provides a new idea for improving image resolution. There are mainly two methods: One is to generate a high-resolution image from a low-resolution image. This image-to-image conversion manner is relatively simple and intuitive because the manner adopts pixel-by-pixel processing. However, due to non-interpretability of neural networks, this method may cause problems such as fake structures, bridges, or overshots at edges, and most existing techniques focus on processing in the image domain. These problems may cause the generated high-resolution image to be misleading in clinical applications, affecting the judgment of doctors.

Another method is to perform prediction from raw projection domain (that is, the sinogram domain). The sinogram domain includes raw projection data acquired in a CT scanning process, which can provide richer information. However, it is very difficult to obtain a good result from the sinogram domain due to sensitivity of the sinogram domain to errors. Any small error may be amplified in a reconstruction process, resulting in degraded final image quality. Therefore, how to effectively extract useful information from the sinogram domain is a problem that needs to be resolved urgently.

### SUMMARY OF THE INVENTION

According to a first aspect of the present disclosure, a method for generating resolution-enhanced medical imaging data is provided, which may comprise: acquiring a raw three-dimensional projection dataset, the raw three-dimensional projection dataset being generated by a medical imaging system scanning a subject under examination; decomposing the raw three-dimensional projection dataset into a set of sub-datasets comprising different frequency information; executing texture orientation feature extraction on each sub-dataset in the set of sub-datasets to generate a set of texture orientation feature maps for each sub-dataset; inputting each sub-dataset in the set of sub-datasets and the set of texture orientation feature maps corresponding to the sub-dataset into a resolution enhancement neural network to generate a resolution-enhanced sub-dataset of each sub-dataset, wherein the resolution-enhanced sub-dataset has a higher resolution than the corresponding sub-dataset in the set of sub-datasets; and synthesizing the resolution-enhanced sub-datasets of all sub-datasets to generate a resolution-enhanced three-dimensional projection dataset corresponding to the raw three-dimensional projection dataset, wherein the resolution-enhanced three-dimensional projection dataset has a higher resolution than the raw three-dimensional projection dataset and is used to reconstruct a medical image of the subject under examination.

In an embodiment, the raw three-dimensional projection dataset may be acquired by a detector of the medical imaging system and comprises three dimensions: a row direction, a channel direction, and a view direction, the row direction indicating a direction of the detector in which the subject under examination moves toward or out of the medical imaging system, the channel direction indicating an extension direction perpendicular to the row direction and along the detector arranged to partially surround the subject under examination, and the view direction indicating angles at which the detector acquires the raw three-dimensional projection dataset at different positions around the subject under examination.

In an embodiment, the decomposition may be executed on a channel-view plane in the raw three-dimensional projection dataset. In an embodiment, executing the decomposition may comprise: executing at least one wavelet transform on two-dimensional projection data in each channel-view plane in the raw three-dimensional projection dataset by using wavelet basis functions of different frequencies. In an embodiment, the synthesis may comprise: performing an inverse transform by using wavelet basis functions that are the same as the wavelet basis functions used in the decomposition. In an embodiment, the method may further comprise: performing denoising processing on the raw three-dimensional projection dataset before executing the decomposition on the raw three-dimensional projection dataset, wherein the decomposition is applied to a denoised raw three-dimensional projection dataset.

In an embodiment, performing denoising processing on the raw three-dimensional projection dataset may comprise: splitting the raw three-dimensional projection dataset alternately in the view direction and/or the row direction to generate a first three-dimensional projection data subset and a second three-dimensional projection data subset; interpolating the first three-dimensional projection data subset to generate a first interpolated data subset, and interpolating the second three-dimensional projection data subset to generate a second interpolated data subset; inputting the first three-dimensional projection data subset and the second interpolated data subset as a first data pair into a denoising neural network to generate a first denoised data subset, and inputting the second three-dimensional projection data subset and the first interpolated data subset as a second data pair into the denoising neural network to generate a second denoised data subset; and synthesizing the first denoised data subset and the second denoised data subset to generate the denoised raw three-dimensional projection dataset.

In an embodiment, the first three-dimensional projection data subset may comprise data blocks at first positions in the view direction, the second three-dimensional projection data subset comprises data blocks at second positions in the view direction, and the first positions and the second positions alternate in the view direction; and/or the first three-dimensional projection data subset comprises data blocks at third positions in the row direction, the second three-dimensional projection data subset comprises data blocks at fourth positions in the row direction, and the third positions and the fourth positions alternate in the row direction. In an embodiment, the medical imaging system may be a computed tomography medical imaging system, a positron emission tomography-computed tomography medical imaging system, or a positron emission tomography medical imaging system.

According to a second aspect of the present disclosure, a method for training a resolution enhancement neural network is provided, which may comprise: acquiring a raw three-dimensional projection dataset, the raw three-dimensional projection dataset being generated by a medical imaging system scanning a subject under examination; decomposing the raw three-dimensional projection dataset into a set of sub-datasets comprising different frequency information; executing texture orientation feature extraction on each sub-dataset in the set of sub-datasets to generate a set of texture orientation feature maps for each sub-dataset; inputting each sub-dataset in the set of sub-datasets and the set of texture orientation feature maps corresponding to the sub-dataset into a resolution enhancement neural network to generate a predicted sub-dataset of each sub-dataset; synthesizing the predicted sub-datasets of all sub-datasets to generate a prediction result; calculating a loss function between the prediction result and a check value, wherein the check value has a resolution higher than that of the raw three-dimensional projection dataset and is used to reconstruct a medical image of the subject under examination; and updating parameters of the resolution enhancement neural network on the basis of the loss function to generate a trained resolution enhancement neural network.

In an embodiment, the loss function may comprise at least one of the following: a mean absolute error loss function between the prediction result and the check value; a mean absolute error loss function between the predicted sub-datasets of all sub-datasets and corresponding sub-datasets of the check value; and a mean absolute error loss function between a texture orientation feature map of the prediction result and a texture orientation feature map of the check value, wherein the corresponding sub-datasets of the check value are generated by executing decomposition on the check value, the texture orientation feature map of the prediction result is generated by executing texture orientation feature extraction on the prediction result, and the texture orientation feature map of the check value is generated by executing texture orientation feature extraction on the check value.

In an embodiment, the raw three-dimensional projection dataset may be acquired by a detector of the medical imaging system and comprises three dimensions: a row direction, a channel direction, and a view direction, the row direction indicating a direction of the detector in which the subject under examination moves toward or out of the medical imaging system, the channel direction indicating an extension direction perpendicular to the row direction and along the detector arranged to partially surround the subject under examination, and the view direction indicating angles at which the detector acquires the raw three-dimensional projection dataset at different positions around the subject under examination.

In an embodiment, the decomposition may be executed on a channel-view plane in the raw three-dimensional projection dataset. In an embodiment, executing the decomposition may comprise: executing at least one wavelet transform on two-dimensional projection data in each channel-view plane in the raw three-dimensional projection dataset by using wavelet basis functions of different frequencies. In an embodiment, the synthesis may comprise: performing an inverse transform by using wavelet basis functions that are the same as the wavelet basis functions used in the decomposition. In an embodiment, the method may further comprise: performing denoising processing on the raw three-dimensional projection dataset before executing the decomposition on the raw three-dimensional projection dataset, wherein the decomposition is applied to a denoised raw three-dimensional projection dataset.

In an embodiment, performing denoising processing on the raw three-dimensional projection dataset may comprise: splitting the raw three-dimensional projection dataset alternately in the view direction and/or the row direction to generate a first three-dimensional projection data subset and a second three-dimensional projection data subset; interpolating the first three-dimensional projection data subset to generate a first interpolated data subset, and interpolating the second three-dimensional projection data subset to generate a second interpolated data subset; inputting the first three-dimensional projection data subset and the second interpolated data subset as a first data pair into a denoising neural network to generate a first denoised data subset, and inputting the second three-dimensional projection data subset and the first interpolated data subset as a second data pair into the denoising neural network to generate a second denoised data subset; and synthesizing the first denoised data subset and the second denoised data subset to generate the denoised raw three-dimensional projection dataset.

In an embodiment, the first three-dimensional projection data subset may comprise data blocks at first positions in the view direction, the second three-dimensional projection data subset comprises data blocks at second positions in the view direction, and the first positions and the second positions alternate in the view direction; and/or the first three-dimensional projection data subset comprises data blocks at third positions in the row direction, the second three-dimensional projection data subset comprises data blocks at fourth positions in the row direction, and the third positions and the fourth positions alternate in the row direction. In an embodiment, the medical imaging system may be a computed tomography medical imaging system, a positron emission tomography-computed tomography medical imaging system, or a positron emission tomography medical imaging system.

According to a third aspect of the present disclosure, a medical imaging system is provided, which may comprise: a scanning device, configured to acquire a raw three-dimensional projection dataset of a subject under examination; and a processor, configured to execute the method according to any one of the foregoing aspects.

According to a fourth aspect of the present disclosure, a non-transient computer-readable medium is provided, having instructions stored thereon, wherein the instructions are executable by a processor to implement the method according to any one of the foregoing aspects.

According to a fifth aspect of the present disclosure, a computer program product is provided, comprising instructions, wherein the instructions are executable by a processor to implement the method according to any one of the foregoing aspects.

### BRIEF DESCRIPTION OF THE DRAWINGS

The present disclosure can be better understood by means of the description of the exemplary embodiments of the present disclosure in conjunction with the drawings, in which:

FIG. 1 shows a schematic diagram of an exemplary CT system 100 configured for CT imaging;

FIG. 2 shows an exemplary imaging system 200 similar to the CT system 100 in FIG. 1;

FIG. 3 shows a schematic diagram of a CT system during patient examination;

FIG. 4 shows a flowchart of an example method 400 for resolution-enhanced medical imaging data according to an embodiment of the present disclosure;

FIG. 5 shows a schematic diagram of a raw three-dimensional projection dataset according to an embodiment of the present disclosure;

FIG. 6 shows a schematic diagram of first-level wavelet decomposition according to an embodiment of the present disclosure;

FIG. 7 shows a schematic diagram of multi-level wavelet decomposition according to an embodiment of the present disclosure;

FIG. 8A shows a schematic diagram of an example neural network model 800 according to an embodiment of the present disclosure;

FIG. 8B shows a schematic diagram of an example residual group according to an embodiment of the present disclosure;

FIG. 8C shows a schematic diagram of an example residual block according to an embodiment of the present disclosure;

FIG. 9 shows a flowchart of an example method 900 for denoising a raw three-dimensional projection dataset according to an embodiment of the present disclosure;

FIG. 10 shows a schematic diagram of splitting a raw three-dimensional projection dataset in a view direction according to an embodiment of the present disclosure;

FIG. 11 shows a schematic diagram of splitting a raw three-dimensional projection dataset in a channel direction according to another embodiment of the present disclosure;

FIG. 12 shows a schematic diagram of splitting a raw three-dimensional projection dataset simultaneously in a view direction and a channel direction according to yet another embodiment of the present disclosure;

FIG. 13 shows a flowchart of an example method 1300 for training a resolution enhancement neural network according to an embodiment of the present disclosure; and

FIG. 14 shows an example block diagram of a computing device 1400 according to an embodiment of the present disclosure.

### DETAILED DESCRIPTION

Specific embodiments of the present disclosure will be described below, but it should be noted that in the specific description of these embodiments, for the sake of brevity of description, it is impossible to describe all features of the actual embodiments of the present disclosure in detail in this description. It should be understood that in the actual implementation process of any implementation, just as in the process of any one engineering project or design project, a variety of specific decisions are often made to achieve specific goals of the developer and to meet system-related or business-related constraints, which may also vary from one implementation to another. Furthermore, it should also be understood that although efforts made in such development processes may be complex and tedious, for a person of ordinary skill in the art related to the content disclosed in the present disclosure, some design, manufacture, or production changes made on the basis of the technical content disclosed in the present disclosure are only common technical means, and should not be construed as the content of the present disclosure being insufficient.

References in the specification to “an embodiment,” “embodiment,” “exemplary embodiment,” and so on indicate that the embodiment described may include a specific feature, structure, or characteristic, but the specific feature, structure, or characteristic is not necessarily included in every embodiment. Besides, such phrases do not necessarily refer to the same embodiment. Further, when a specific feature, structure, or characteristic is described in connection with an embodiment, it is believed that affecting such feature, structure, or characteristic in connection with other embodiments (whether or not explicitly described) is within the knowledge of those skilled in the art.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Unless otherwise defined, the technical or scientific terms used in the claims and the description should be as they are usually understood by those possessing ordinary skill in the technical field to which they belong. The terms “include” or “comprise” and similar words indicate that an element or object preceding the terms “include” or “comprise” encompasses elements or objects and equivalent elements thereof listed after the terms “include” or “comprise”, and do not exclude other elements or objects.

The term “projection domain” (also referred to as sinogram domain) refers to a set of raw projection data acquired from different angles during an imaging scan. The data is a ray signal received by a detector, and reflects attenuation information of a scanned subject at different angles. In the projection domain, acquisition of data is angle-dependent, i.e., different scanning angles produce different projection data. The raw data is a basis for a subsequent image reconstruction process, and a reconstruction algorithm (such as filtered back projection, iterative reconstruction, or the like) converts the projection data into image domain, and finally generates a visualized image.

The term “image domain” is the visualized image obtained by reconstructing the projection data, and displays structures and features inside the subject. The data in the image domain is typically presented in the form of a two-dimensional or three-dimensional image, with values of pixels or voxels corresponding to attenuation coefficients or densities inside the subject. In the process of generating the image domain, the projection data is processed by using reconstruction algorithms. These algorithms integrate projection data acquired from different angles to eliminate noise and artifacts, thereby generating a high-quality image.

As described above, it is often difficult to obtain a good result through prediction from the sinogram domain due to sensitivity of the sinogram domain to errors. In view of this challenge, the present disclosure provides a method for generating a resolution-enhanced dataset in the sinogram domain. The method decomposes a raw dataset, and extracts texture orientation features from sub-datasets of different frequencies after decomposition, as additional inputs of a resolution enhancement neural network. The resolution-enhanced sub-datasets may be re-synthesized, so as to obtain a resolution-enhanced projection dataset. Finally, the resolution of a reconstructed image can be improved, and limitations of a conventional method can be overcome to provide higher-quality image data for medical imaging.

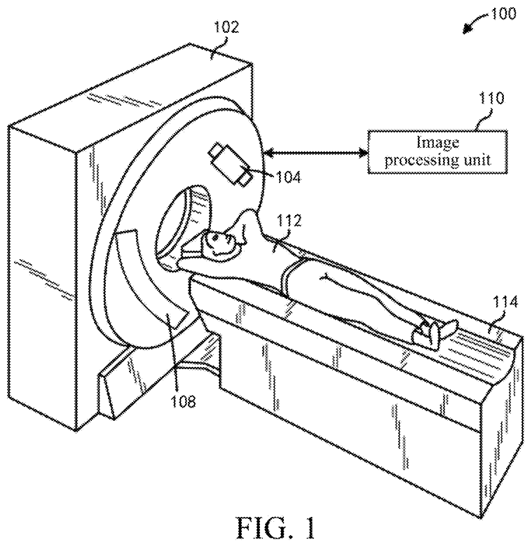

Embodiments of the present disclosure will be described below by way of example with reference to FIG. 1 to FIG. 14. Although a CT system is described by way of example, it should be understood that the techniques of the present disclosure are broadly applicable to various fields of non-destructive examination. The techniques of the present disclosure may also be applicable when applied to images acquired by using other imaging modalities, such as X-ray imaging systems, positron emission tomography (PET) imaging systems, single photon emission computed tomography (SPECT) imaging systems, and combinations thereof (e.g., multi-modal imaging systems such as PET/CT, or SPECT/CT imaging systems). As an example, the embodiments of the present disclosure are described below in conjunction with X-ray computed tomography (CT) imaging. It will be understood by those skilled in the art that the embodiments of the present disclosure may also be applied to other medical imaging.

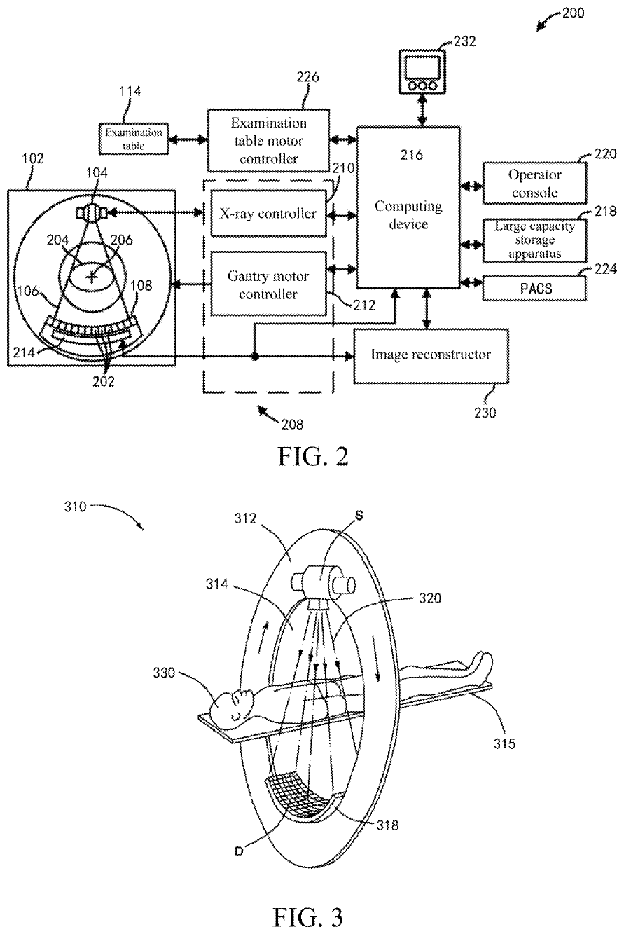

FIG. 1 shows a schematic diagram of an exemplary CT system 100 configured for CT imaging. Specifically, the CT system 100 is configured to image a subject 112 (such as a patient, an inanimate object, or one or more manufactured components) and/or a foreign object (such as a dental implant, a stent, and/or a contrast agent present in the body). In an embodiment, the CT system 100 includes a gantry 102, which in turn may further include at least one X-ray source 104. The at least one X-ray source is configured to project an X-ray radiation beam 106 (see FIG. 2) for imaging the subject 112 lying on an examination table 114. Specifically, the X-ray source 104 is configured to project the X-ray radiation beam 106 toward a detector array 108 positioned on the opposite side of the gantry 102. Although FIG. 1 depicts a single X-ray source 104, in certain implementations, a plurality of X-ray sources and detectors may be used to project a plurality of X-ray radiation beams, so as to acquire projection data corresponding to the patient at different energy levels. In some embodiments, the X-ray source 104 may achieve dual-energy gemstone spectral imaging (GSI) through rapid peak kilovoltage (kVp) switching. In some implementations, the X-ray detectors used are photon counting detectors capable of distinguishing X-ray photons of different energies. In other implementations, dual-energy projections are generated using two sets of X-ray sources and detectors, wherein one set of X-ray sources and detectors is set to low kVp and the other set is set to high kVp. It should therefore be understood that the methods described herein may be implemented using single-energy acquisition techniques and dual-energy acquisition techniques.

In certain implementations, the CT system 100 further includes an image processing unit 110, and the image processing unit is configured to reconstruct images of a target volume of the subject 112 by using iterative or analytical image reconstruction methods. For example, the image processing unit 110 may reconstruct images of a target volume of the patient by using analytical image reconstruction methods such as filtered back projection (FBP). As another example, the image processing unit 110 may use iterative image reconstruction methods (such as advanced statistical iterative reconstruction (ASIR), conjugate gradient (CG), maximum likelihood expectation maximization (MLEM), model-based iterative reconstruction (MBIR), and the like) to reconstruct images of a target volume of the subject 112. As further described herein, in some examples, in addition to iterative image reconstruction methods, the image processing unit 110 may further use analytical image reconstruction methods (such as FBP).

In some CT imaging system configurations, the X-ray source projects a conical X-ray radiation beam, which is collimated to be located within an X-Y-Z plane of a Cartesian coordinate system, and the plane is usually referred to as an “imaging plane”. The X-ray radiation beam passes through an object being imaged, such as a patient or a subject. After being attenuated by the object, the X-ray radiation beam is incident on an array of detector elements. The intensity of the attenuated X-ray radiation beam received at the detector array depends on the attenuation of the X-ray radiation beam by the subject. Each detector element of the array produces a separate electrical signal, the separate electrical signal being a measurement of X-ray beam attenuation at the detector position. Attenuation measurements from all detector elements are individually acquired to generate a transmission distribution.

In some CT systems, a gantry is used to rotate, in the imaging plane, the X-ray source and the detector array around the subject to be imaged, so that the angle at which the X-ray beam intersects the subject continually changes. A set of X-ray radiation attenuation measurement results (e.g., projection data) from the detector array at a gantry angle is referred to as a “view”. A “scan” of the subject includes a set of views made at different gantry angles or viewing angles during a single rotation of the X-ray source and detector. It can be contemplated that benefits of the method in this specification derive from a medical imaging modality other than CT. Therefore, as used herein, the term “view” is not limited to the use described above with respect to projection data from one gantry angle. The term “view” is used to mean one data acquisition when there are a plurality of data acquisitions (acquisitions from CT, positron emission tomography (PET), or single photon emission CT (SPECT)) from different angles, and/or any other modality (including a modality to be developed) and combinations thereof in fused embodiments.

Projection data is processed to reconstruct images corresponding to two-dimensional slices acquired through the subject, or, in some examples in which the projection data includes a plurality of views or scans, to reconstruct images corresponding to three-dimensional images of the subject. A method for reconstructing an image from a set of projection data is referred to as a filtered back projection technique in the art. Transmission and emission tomography reconstruction techniques also include statistical iterative methods, such as maximum likelihood expectation maximization (MLEM) and ordered subset expectation reconstruction techniques, as well as iterative reconstruction techniques. The method converts an attenuation measurement from a scan into an integer referred to as a “CT number” or “Hounsfield unit”, which is used to control the brightness of a corresponding pixel on a display device.

To reduce the total scan time, a “helical” scan may be executed. To execute the “helical” scan, the patient is moved when data of a specified number of slices is acquired. Such systems produce a single helix from helical scanning of a conical beam. The helix mapped out by the conical beam produces projection data, and an image in each specified slice can be reconstructed based on the projection data.

As used herein, the phrase “reconstructing an image” is not intended to exclude embodiments in which data representing an image is generated without producing a visual image. Thus, as used herein, the term “image” broadly refers to both a visual image and data representing a visual image. However, many embodiments generate (or are configured to generate) at least one visual image.

FIG. 2 shows an exemplary imaging system 200 similar to the CT system 100 in FIG. 1. According to aspects of the present disclosure, the imaging system 200 is configured to image a subject 204 (e.g., the subject 112 of FIG. 1). In an embodiment, the imaging system 200 includes the detector array 108 (see FIG. 1). The detector array 108 further includes a plurality of detector elements 202, which together sense the X-ray radiation beam 106 (see FIG. 2) passing through the subject 204 (such as a patient) to acquire corresponding projection data. Therefore, in one implementation, the detector array 108 is fabricated in a multi-row or multi-line configuration including a plurality of rows or lines of units or detector elements 202. In such a configuration (e.g., multi-row or multi-line detector CT or MDCT), another row or a plurality of rows of detector elements 202 are arranged in a parallel configuration to acquire projection data. The configuration may include 4, 8, 16, 32, 64, 128, or 256 lines or rows of detector elements. For example, a 64-row MDCT scanner may have 64 rows or lines of detector elements, while a 256-row MDCT scanner may have 256 rows or lines of detector elements. Therefore, four rotations of a helical scan executed by a 64-row or 64-line MDCT scanner can achieve a detector coverage equal to a single rotation of a scan executed by a 256-row or 256-line MDCT scanner.

In certain implementations, the imaging system 200 is configured to traverse different angular positions around the subject 204 to acquire required projection data. Therefore, the gantry 102 and components mounted thereon can be configured to rotate about a center of rotation 206 to acquire projection data at different energy levels, for example. Alternatively, in implementations in which the projection angle with respect to the subject 204 changes over time, the mounted components may be configured to move along a generally curved line rather than along a segment of a circular arc.

Therefore, when the X-ray source 104 and the detector array 108 rotate, the detector array 108 collects data of the attenuated X-ray beam. The data collected by the detector array 108 is then subjected to pre-processing and calibration to adjust the data so as to represent line integrals of attenuation coefficients of the scanned subject 204. The processed data is generally referred to as a projection.

In some examples, individual detectors or detector elements 202 in the detector array 108 may include photon counting detectors which register interactions of individual photons into one or more energy bins. It should be understood that the method described herein may also be implemented using an energy integration detector.

An acquired projection dataset may be used for base material decomposition (BMD). During the BMD, the measured projection is converted to a set of material density projections. The material density projections may be reconstructed to form a pair or a set of material density maps or images (such as bone, soft tissue, and/or contrast agent maps) of each corresponding base material. The density maps or images may then be correlated to form a 3D volumetric image of the base material (e.g., bone, soft tissue, and/or a contrast agent) in the imaging volume.

Once reconstructed, the base material image produced by the imaging system 200 displays the internal features of the subject 204 represented in terms of the densities of two base materials. The density images can be displayed to demonstrate the foregoing features. In a conventional method for diagnosing medical conditions (such as disease states), and more generally for diagnosing medical events, a radiologist or physician considers a hard copy or display of a density image to discern characteristic features of interest. Such features may include a lesion, size, and shape of a particular anatomical structure or organ, and other features should be discernible in the image on the basis of the skill and knowledge of an individual practitioner.

In one implementation, the imaging system 200 includes a control mechanism 208 to control movement of components, such as the rotation of the gantry 102 and the operation of the X-ray source 104. In certain embodiments, the control mechanism 208 further includes an X-ray controller 210, which is configured to provide power and timing signals to the X-ray source 104. Additionally, the control mechanism 208 includes a gantry motor controller 212, which is configured to control the rotational speed and/or position of the gantry 102 on the basis of imaging requirements.

In certain embodiments, the control mechanism 208 further includes a data acquisition system (DAS) 214, which is configured to sample analog data received from the detector elements 202, and to convert the analog data into digital signals for subsequent processing. The DAS 214 may further be configured to selectively aggregate analog data from a subset of the detector elements 202 into a so-called macro detector, as described further herein. The data sampled and digitized by the DAS 214 is transmitted to a computer or computing device 216. In an example, the computing device 216 stores data in a storage device or large-capacity storage apparatus 218. For example, the storage device 218 may include a hard disk drive, a floppy disk drive, a compact disc-read/write (CD-R/W) drive, a digital versatile disc (DVD) drive, a flash drive, and/or a solid-state storage drive.

Additionally, the computing device 216 provides commands and parameters to one or more of the DAS 214, the X-ray controller 210, and the gantry motor controller 212 to control system operations, such as data acquisition and/or processing. In certain embodiments, the computing device 216 controls system operations on the basis of operator input. The computing device 216 receives the operator input by means of an operator console 220 that is operably coupled to the computing device 216, the operator input including, for example, commands and/or scan parameters. The operator console 220 may include a keyboard (not shown) or a touch screen to allow the operator to specify commands and/or scan parameters.

Although FIG. 2 shows one operator console 220, more than one operator console may be coupled to the imaging system 200, and, for example, are used to input or output system parameters, request examination, map data, and/or view images. Moreover, in certain embodiments, the imaging system 200 may be coupled to, for example, a plurality of displays, printers, workstations, and/or similar devices located locally or remotely within an institution or hospital or in a completely different location via one or more configurable wired and/or wireless networks (such as the Internet and/or a virtual private network, a wireless telephone network, a wireless local area network, a wired local area network, a wireless wide area network, a wired wide area network, and the like).

In an embodiment, for example, the imaging system 200 includes a picture archiving and communication system (PACS) 224, or is coupled to the PACS. In one exemplary embodiment, the PACS 224 is further coupled to a remote system (such as a radiology information system or a hospital information system), and/or an internal or external network (not shown) to allow operators in different locations to provide commands and parameters and/or acquire access to image data.

The computing device 216 uses operator-supplied and/or system-defined commands and parameters to operate an examination table motor controller 226, which can in turn control the examination table 114. The examination table may be an electric examination table. Specifically, the examination table motor controller 226 may move the examination table 114 to properly position the subject 204 in the gantry 102, so as to acquire projection data corresponding to a target volume of the subject 204.

As described previously, the DAS 214 samples and digitizes projection data acquired by the detector elements 202. Subsequently, an image reconstructor 230 uses the sampled and digitized X-ray data to execute high-speed reconstruction. Although the image reconstructor 230 is shown as a separate entity in FIG. 2, in certain implementations, the image reconstructor 230 may form a part of the computing device 216. Alternatively, the image reconstructor 230 may not be present in the imaging system 200, and the computing device 216 may instead execute one or more functions of the image reconstructor 230. In addition, the image reconstructor 230 may be located locally or remotely and may be operably connected to the imaging system 200 by using a wired or wireless network. Specifically, in one exemplary embodiment, computing resources in a “cloud” network cluster may be used for the image reconstructor 230.

In one embodiment, the image reconstructor 230 stores a reconstructed image in the storage device 218. Alternatively, the image reconstructor 230 may transmit the reconstructed image to the computing device 216 to generate usable patient information for diagnosis and evaluation. In certain implementations, the computing device 216 may transmit the reconstructed image and/or patient information to a display or display device 232, the display or display device being communicatively coupled to the computing device 216 and/or the image reconstructor 230. In some implementations, the reconstructed image may be transmitted from the computing device 216 or the image reconstructor 230 to the storage device 218 for short-term or long-term storage.

FIG. 3 shows a schematic diagram of a CT system during patient examination. As shown in FIG. 3, the CT system 310 generally includes a rotatable gantry 312 and a support table 315 disposed in a hollow imaging region 314 of the rotatable gantry 312 for carrying a patient 330. The rotatable gantry 312 includes an X-ray source S and a detector 318 disposed opposite to the X-ray source S, wherein the detector 318 includes a plurality of independent detector units D arranged in an array. When the rotatable gantry 312 is located at a certain scanning position, the X-ray source S emits a fan-shaped X-ray beam 320 toward the detector 318, and the plurality of detector units D separately sense X-rays attenuated by the patient 330, so that a set of projection data is obtained by the detector units D through sensing, thereby obtaining a corresponding frame of projection data. As the rotatable gantry 312 rotates, the X-ray source S and the detector 318 rotate around a center of rotation O. The CT system 310 performs multiple scans, and during each scan, all the detector units D may obtain each corresponding frame of projection data through sensing. Under normal operation of the detector units D, each corresponding frame of projection data can be directly used to reconstruct one or more images. A direction of the detector 318 in which a subject under examination moves toward or out of the medical imaging system is referred to as a row direction, that is, a direction in which the subject under examination on the support table 315 moves toward or out of the rotatable gantry 312. An extension direction perpendicular to the row direction and along the detector 318 arranged to partially surround a subject under examination is referred to as a channel direction, that is, a direction in which the detector 318 is arranged in an arc shape along the rotatable gantry 312. Angles at which the detector 318 acquires raw projection data at different positions around the subject under examination are referred to as view directions, that is, different angles at which the detector 318 surrounds the subject under examination along the rotatable gantry 312.

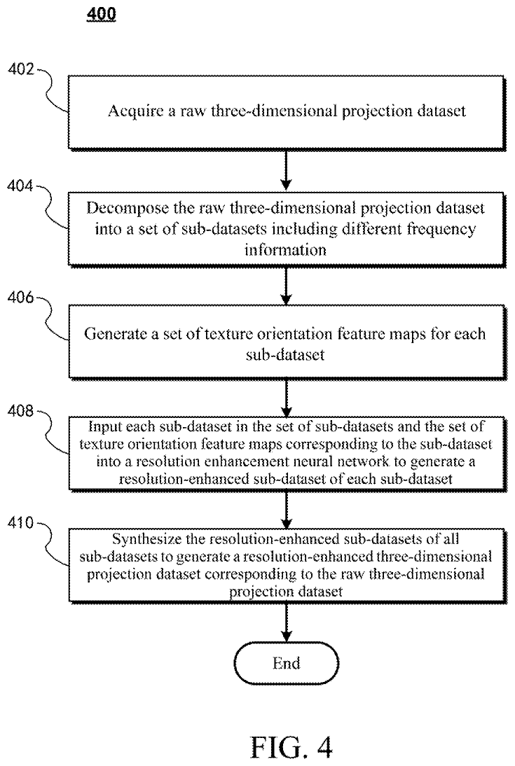

FIG. 4 shows a flowchart of an example method 400 for resolution-enhanced medical imaging data according to an embodiment of the present disclosure. First, at block 402, a raw three-dimensional projection dataset is acquired. The raw three-dimensional projection dataset is obtained by a medical imaging system scanning a subject under examination.

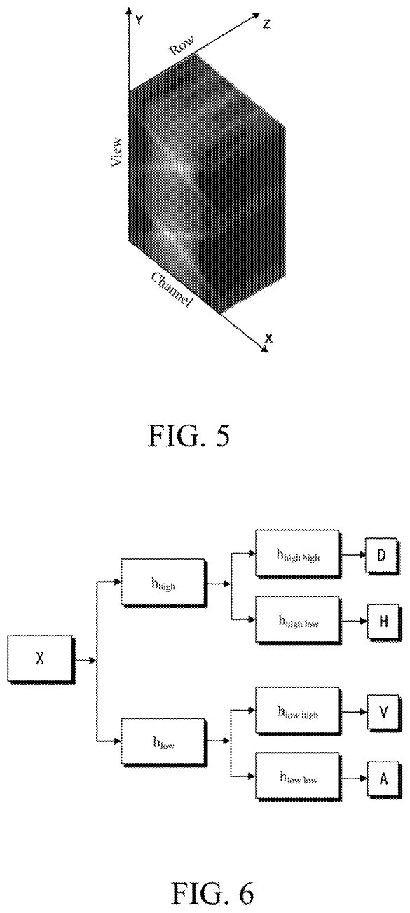

FIG. 5 shows a schematic diagram of a raw three-dimensional projection dataset according to an embodiment of the present disclosure. The raw three-dimensional projection dataset is a three-dimensional projection dataset acquired by a detector of a medical imaging system, and is projection domain data. For example, the raw three-dimensional projection dataset is acquired by the detector array 108 or the detector 318 of the CT system 100, 200, or 310 described in FIGS. 1 to 3. In an embodiment, the medical imaging system may be a computed tomography (CT) medical imaging system, a positron emission tomography-computed tomography (PET-CT) medical imaging system, or a positron emission tomography (PET) medical imaging system. The raw three-dimensional projection dataset shown in part (a) includes three dimensions, namely, a row direction (Z direction), a channel direction (X direction), and a view direction (Y direction). The row direction (Z direction) indicates a direction of the detector in which the subject under examination moves toward or out of the medical imaging system, i.e., a scanning translation direction of the medical imaging system. For example, the detector array 108 or the detector 318 of the CT system 100, 200, or 310 may be configured with different numbers of rows of detector units in the row direction (the Z direction), for example, may include 8 rows, 16 rows, 32 rows, 64 rows, 256 rows, 512 rows, and the like. The channel direction (the X direction) indicates an extension direction perpendicular to the row direction and along the detector arranged to partially surround the subject under examination, i.e., a width direction of the detector array 108 or the detector 318 of the medical imaging system. For example, there may be about 900 channels. The view direction (the Y direction) indicates angles at which the detector acquires the raw three-dimensional projection dataset at different positions around the subject under examination, for example, an angle or view angle at which the detector array 108 or the detector 318 rotates with the gantry when a view is acquired by the CT system 100, 200, or 310 described in FIGS. 1 to 3. For example, in an axial scan, the medical imaging system may acquire raw projection data or views at about 1000 angular positions, one angular position being referred to as one viewing angle.

At block 404, the raw three-dimensional projection dataset is decomposed into a set of sub-datasets including different frequency information. Wavelet transform may be used for decomposition. The wavelet transform can provide information in both the time (or space) domain and the frequency domain simultaneously by decomposing a signal into components of different frequencies. Specifically, for data of each channel-view plane or each row of data in the raw three-dimensional projection dataset, the data is decomposed into sub-bands (i.e., sub-datasets) of different frequencies and resolutions layer by layer through wavelet transform to extract low-frequency and high-frequency information of the signal. Each level of decomposition decomposes the dataset into a low-frequency portion and a high-frequency portion. The low-frequency portion includes overall contour or low-frequency information of the signal. The high-frequency portion includes details or high-frequency information of the signal.

FIG. 6 shows a schematic diagram of first-level wavelet decomposition according to an embodiment of the present disclosure. In FIG. 6, the symbol “X” represents raw data to be decomposed, i.e., data of a channel-view plane or a row of data in the raw three-dimensional projection dataset. First, the raw data is decomposed into a high-frequency portion h_{high} and a low-frequency portion h_{low} by using wavelet basis functions of different frequencies. The high-frequency portion h_{high} and the low-frequency portion h_{low} are further decomposed respectively to obtain four portions: h_{high high}, h_{high low}, h_{low high}, and h_{low low} as a result of first-level decomposition. h_{high high} is used to represent an overall trend and main features of the signal, and is represented by an approximation coefficient A, which includes low-frequency information of the signal and can effectively capture a main contour of the signal. h_{high low} is used to capture detailed features of the signal in a horizontal direction, and is represented by a horizontal coefficient H, which provides high-frequency information of the signal in the horizontal direction, and helps identify edges and textures. h_{loq high} is used to capture detailed features of the signal in a vertical direction, and is represented by a vertical coefficient V, which reflects high-frequency information of the signal in the vertical direction, and can reveal a vertical edge and details of an image. h_{low low} is used to capture detailed features of the signal in a diagonal direction, and is represented by a diagonal coefficient D, which provides high-frequency information of the signal in the diagonal direction, and can more comprehensively describe texture features of the image. These coefficients A, H, V, and D are obtained by performing low-pass and high-pass filtering on the signal and then performing downsampling, which can help extract different features of the signal.

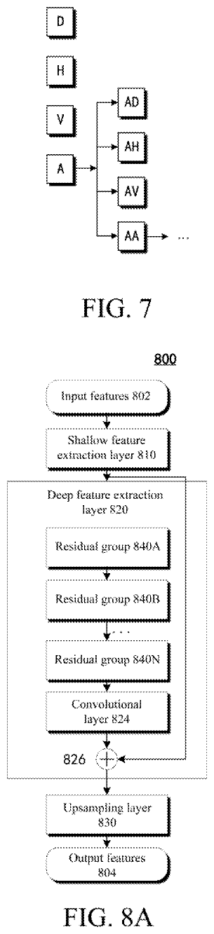

FIG. 7 shows a schematic diagram of multi-level wavelet decomposition according to an embodiment of the present disclosure. On the basis of the first-level decomposition, one or more of the four portions A, H, V, and D may be further decomposed. In this embodiment, the approximation coefficient A is selected to be further decomposed. The further decomposition may be performed by the same method as the first-level decomposition, thereby obtaining second-level decomposition results AD, AH, AV, and AA of the approximation coefficient A, wherein AA is a second-level approximation coefficient obtained by performing second-level decomposition on the first-level approximation coefficient A, AH is a second-level horizontal coefficient obtained by performing second-level decomposition on the first-level approximation coefficient A, AV is a second-level vertical coefficient obtained by performing second-level decomposition on the first-level approximation coefficient A, and AD is a second-level diagonal coefficient obtained by performing second-level decomposition on the first-level approximation coefficient A. When performing third-level or more levels of decomposition, decomposition may be performed only on the approximation coefficient, because the approximation coefficient includes main information and trends of the signal, and further decomposition can extract the detailed features of the signal more deeply, while the high-frequency portions (such as H, V, D) are usually not further decomposed in multi-level decomposition.

The wavelet transform described herein may employ a variety of wavelet basis functions, including, but not limited to, Haar Wavelet, Daubechies Wavelet, Symlets Wavelet, Coiflet Wavelet, Biorthogonal Wavelet, Mexican Hat Wavelet, Morlet Wavelet, Gaussian Wavelet, and the like.

By using the wavelet transform described in FIGS. 6 and 7, the raw three-dimensional projection dataset can be decomposed into a set of sub-datasets including different frequency information. The sub-datasets may be (A, H, V, D) obtained through first-level wavelet decomposition, or may be (AA, AH, AV, AD, H, V, D) obtained through second-level wavelet decomposition. It can be understood that, in the case of second-level wavelet decomposition, the approximation coefficient A obtained through first-level wavelet decomposition may be discarded. In addition, multi-level wavelet decomposition may be employed to obtain more information of different frequencies. Multi-level wavelet decomposition may be performed only for the approximation coefficient AA obtained through second-level wavelet decomposition.

Referring again to FIG. 4, at block 406, for each of AA, AH, AV, AD, H, V, D in the set of sub-datasets, for example, (AA, AH, AV, AD, H, V, D), obtained at block 404, texture orientation feature extraction is executed to generate a set of texture orientation feature maps for each sub-dataset. Texture orientation feature extraction is used to extract texture directionality and structural information from the image. As an example, a Gabor filter may be employed. The Gabor filter is a linear filter, which combines a Gaussian function and a sine wave, and has good time-frequency localization characteristics. The Gabor filter is mathematically expressed by the following equation 1:

$$g ( x , y ) = \frac{1}{2 π {σ}^{2}} {e}^{- \frac{{x}^{2} + {y}^{2}}{2 {σ}^{2}}} {e}^{j ( 2 π {f}_{0} x + θ )} \qquad Equation 1$$

wherein: g(x, y) is an output of the Gabor filter; a is a standard deviation of a Gaussian function, and controls the width of the filter; f₀ is the frequency of the filter, and controls the scale of the filter; and θ is the direction of the filter, and controls the direction of the filter.

A combination of a plurality of frequencies and orientations may be used to form a Gabor filter group. For example, four directions (0°, 45°, 90°, and 135°) and three frequencies (low, medium, and high) may be selected, and a total of 12 Gabor filters may be constructed. Each constructed Gabor filter is applied to an input image for convolution, thereby obtaining a filtered response image.

A feature map may be extracted from each Gabor response image, for example: energy, which calculates the energy of each response image, and reflects the strength of a texture; a mean value, which calculates a mean value of each response image, and reflects the brightness of the texture; a variance, which calculates a variance of each response image, and reflects a contrast of the texture; and a directional feature, which can analyze a main orientation of the texture by comparing Gabor responses in different directions. Thus, a set of texture orientation feature maps can be generated for each sub-dataset.

In block 408, each sub-dataset in the set of sub-datasets decomposed in block 404 and the corresponding set of texture orientation feature maps generated in block 406 are inputted in to a resolution enhancement neural network to generate a resolution-enhanced sub-dataset of each sub-dataset.

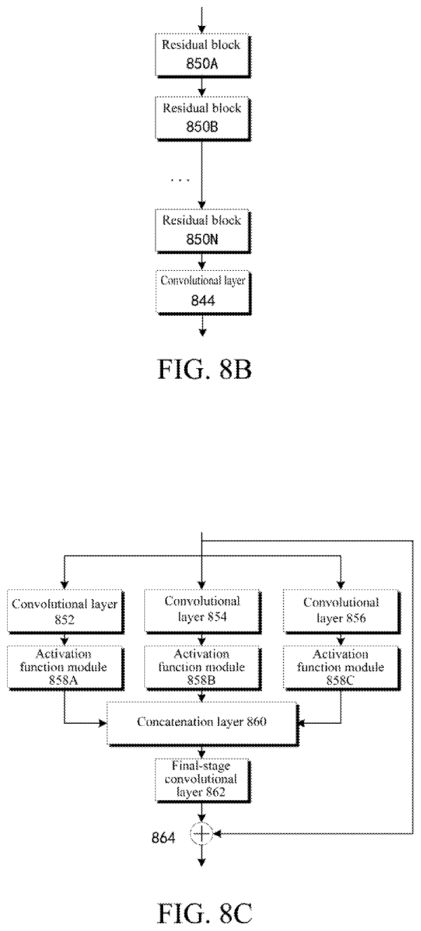

The resolution enhancement neural network is used to increase the resolution of the input projection data. FIG. 8A shows a schematic diagram of an example neural network model 800 according to an embodiment of the present disclosure. In this embodiment, the neural network model 800 may employ a residual channel attention network (RCAN). The neural network model 800 may receive each sub-dataset in the set of sub-datasets decomposed in block 404 and the corresponding set of texture orientation feature maps generated in block 406 as inputs and output enhanced projection data, i.e., the resolution-enhanced sub-dataset, wherein the resolution-enhanced sub-dataset has a higher resolution than the inputted sub-dataset. The neural network model 800 includes a shallow feature extraction layer 810, a deep feature extraction layer 820, and an upsampling layer 830. The shallow feature extraction layer 810 may include a convolutional layer, for example, a two-dimensional convolutional layer. The shallow feature extraction layer 810 is configured to perform feature extraction on input features 802 to obtain shallow features. The deep feature extraction layer 820 may include at least one residual group 840A, 840B, . . . , and 840N, a convolutional layer 824, and a summation module 826 that are cascaded, and is configured to perform feature extraction on the shallow features from the shallow feature extraction layer 810 to obtain deep features. The upsampling layer 830 may upsample the deep features from the deep feature extraction layer 820 to obtain output features 804 of a desired resolution to serve as the enhanced projection data. For example, the upsampling layer 830 may include a pixel shuffle layer and a convolutional layer.

FIG. 8B shows a schematic diagram of an example residual group according to an embodiment of the present disclosure. The residual group may include a plurality of cascaded residual blocks 850A, 850B, . . . , and 850N as well as a convolutional layer 844. Each of the residual blocks 850A, 850B, . . . , and 850N may extract deep features of a different level from an input of the residual group. The convolutional layer 844 may execute a convolution operation on the concatenated deep features to obtain an output of the residual group.

FIG. 8C shows a schematic diagram of an example residual block according to an embodiment of the present disclosure. The residual block includes a plurality of parallel convolutional layers 852, 854, and 856 of different sizes, activation function modules 858A, 858B, and 858C each cascaded with one of the convolutional layers, a concatenation layer 860, a final-stage convolutional layer 862, and a summation module 864. Each of the convolutional layers 852, 854, and 856 is configured to execute a convolution operation on an input of the residual block to obtain a convolution result. The convolutional layers 852, 854, and 856 use convolutional kernels of different sizes, for example, the convolutional layer 852 uses a convolutional kernel having a size of 1×1, the convolutional layer 854 uses a convolutional kernel having a size of 3×3, and the convolutional layer 856 uses a convolutional kernel having a size of 5×5, thereby implementing multi-scale feature extraction by introducing receptive fields of different sizes. The activation function modules 858A, 858B, and 858C each are cascaded with one of the convolutional layers 852, 854, and 856, and each are configured to apply an activation function to a convolution result of the corresponding convolutional layer to obtain a local feature. The activation function modules 858A, 858B, and 858C may employ a leaky rectified linear unit (Leaky ReLU) layer. One convolutional layer and one activation function module form one sub-branch of the residual block, wherein the convolutional layer 852 and the activation function module 858A form a first sub-branch, the convolutional layer 854 and the activation function module 858B form a second sub-branch, and the convolutional layer 856 and the activation function module 858C form a third sub-branch. Although FIG. 8C shows only three sub-branches, it should be understood that the number of sub-branches may be set as required, and the sizes of the convolutional layers may also be selected as required, without being limited to the example of FIG. 8C. The concatenation layer 860 may concatenate the local features generated by the activation function modules 858A, 858B, and 858C to obtain concatenated local features. The final-stage convolutional layer 862 may execute a convolution operation on the concatenated local features to obtain a final-stage convolution result. The summation module 864 may add the final-stage convolution result to the input of the residual block to obtain an output of the residual block.

An example of the resolution enhancement neural network is described above. However, it should be understood that any neural network having such functions may be used, which is not limited in the present application. Examples of the resolution enhancement neural network may further include, but are not limited to, a super resolution convolutional neural network (SRCNN), a very deep super resolution (VDSR), a deeply-recursive convolutional network (DRCN), an enhanced deep super resolution (EDSR), and an enhanced super resolution generative adversarial network (ESRGAN).

Referring again to FIG. 4, in block 410, the resolution-enhanced sub-datasets of all sub-datasets generated by the resolution enhancement neural network in block 408 are synthesized to generate a resolution-enhanced three-dimensional projection dataset corresponding to the raw three-dimensional projection dataset obtained in block 402.

The synthesis in block 410 may employ an inverse operation of the decomposition in block 404. For example, in the case of decomposition using wavelet transform in block 404, the sub-signals and detail information may be recombined in block 410 through an inverse transform by using wavelet basis functions that are the same as those used in the decomposition to generate a synthesized signal. The synthesized signal can then be used to reconstruct a medical image, for example a CT image, of the subject under examination.

According to this embodiment, since each sub-signal (i.e., the sub-dataset) of the raw three-dimensional projection dataset is increased in resolution by the resolution enhancement neural network between the decomposition and synthesis processes, the synthesized three-dimensional projection dataset, i.e., the resolution-enhanced three-dimensional projection dataset, has a higher resolution than the raw three-dimensional projection dataset in block 402.

In this embodiment, before each decomposed sub-dataset is inputted into the resolution enhancement neural network, one or more texture orientation feature maps are further extracted from each sub-dataset through texture feature extraction. By analyzing texture information in the sub-dataset, a feature map reflecting the texture orientation and structure in the image is extracted. These feature maps can effectively capture details and local features of the image. Then, each sub-dataset and the corresponding texture orientation feature map are jointly constructed as input features to form a comprehensive input dataset, and the comprehensive input dataset is inputted into the resolution enhancement neural network. In this way, the network not only can use the information in the raw dataset, but also can take into account additional context information provided by the texture orientation feature maps, thereby significantly improving prediction accuracy when the resolution is increased in the projection domain. The method of this embodiment effectively enhances the network's ability to understand the details of the image, and finally improves the quality of the reconstructed image.

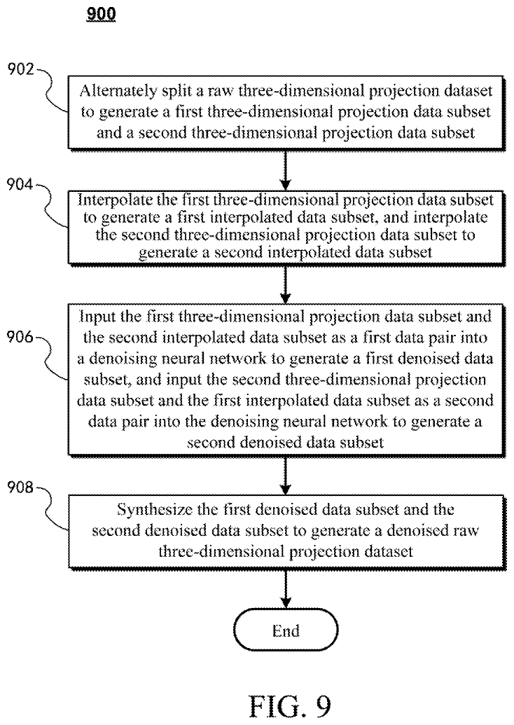

In some embodiments, before the decomposition is executed on the raw three-dimensional projection dataset in block 404, denoising processing may be performed on the raw three-dimensional projection dataset in advance. FIG. 9 shows a flowchart of an example method 900 for denoising a raw three-dimensional projection dataset according to an embodiment of the present disclosure.

First, at block 902, the raw three-dimensional projection dataset is alternately split to generate a first three-dimensional projection data subset and a second three-dimensional projection data subset. The splitting of the raw three-dimensional projection dataset may be performed in the view direction and/or the row direction.

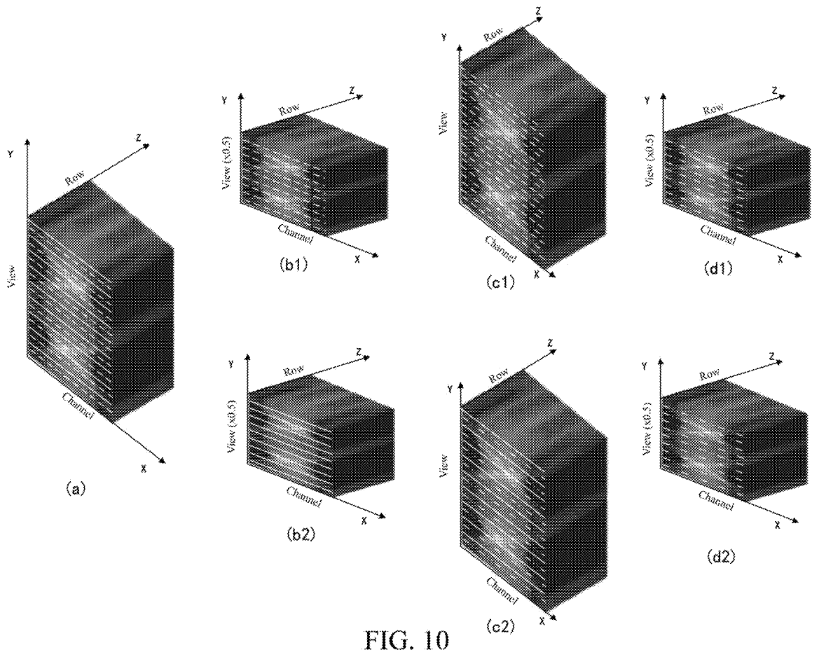

FIG. 10 shows a schematic diagram of splitting a raw three-dimensional projection dataset in a view direction according to an embodiment of the present disclosure. Part (a) shows the raw three-dimensional projection dataset. Then, the raw three-dimensional projection dataset is alternately split in the view direction to obtain a first three-dimensional projection data subset represented by dashed lines shown in part (b1) and a second three-dimensional projection data subset represented by solid lines shown in part (b2), wherein part (b1) is located at first positions in the view direction of part (a), part (b2) is located at second positions in the view direction of part (a), the first positions and the second positions alternate in the view direction, and therefore, a multiplication factor in the view direction of part (b1) and part (b2) is reduced to 0.5 times. Although the splits shown in the figure are equally spaced, in other embodiments, unequally spaced splits may also be used. For example, a smaller interval split is used at the center of the image, a larger interval split is used at the edge of the image, and so on.

Referring again to FIG. 9, at block 904, the first three-dimensional projection data subset is interpolated to generate a first interpolated data subset, and the second three-dimensional projection data subset is interpolated to generate a second interpolated data subset. With continued reference to FIG. 10, the first three-dimensional projection data subset shown in part (b1) is interpolated to obtain part (c1), wherein an interpolated part (d1) is represented by one-dot chain lines, and the multiplication factor in the view direction of the interpolated part shown in part (d1) is 0.5 times. Since the interpolated part in part (d1) and the first projection data subset in part (b1) are alternately arranged, there is a correspondence with the second three-dimensional projection data subset shown in part (b2), and the interpolated part shown in part (d1) is referred to as the first interpolated data subset herein. Therefore, the first interpolated data subset in part (d1) and the non-interpolated second three-dimensional projection data subset in part (b2) may form a set of projection data pairs.

Similar processing may be performed on the second three-dimensional projection data subset shown in part (b2). The second three-dimensional projection data subset shown in part (b2) is interpolated to obtain part (c2), wherein an interpolated part (d2) is represented by two-dot chain lines, and the multiplication factor in the view direction of the interpolated part shown in part (d2) is 0.5 times. Since the interpolated part in part (d2) and the second three-dimensional projection data subset in part (b2) are alternately arranged, there is a correspondence with the first three-dimensional projection data subset shown in part (b1), and the interpolated part shown in part (d2) is referred to as the second interpolated data subset herein. Therefore, the second interpolated data subset in part (d2) and the non-interpolated first three-dimensional projection data subset in part (b1) may form another set of projection data pairs.

In an embodiment, the first three-dimensional projection data subset and the second three-dimensional projection data subset may be obtained by alternately splitting the raw three-dimensional projection dataset in the channel direction. FIG. 11 shows a schematic diagram of splitting a raw three-dimensional projection dataset in a channel direction according to another embodiment of the present disclosure. Part (a) shows the raw three-dimensional projection dataset. The raw three-dimensional projection dataset is alternately split in the channel direction to obtain a first three-dimensional projection data subset represented by dashed lines shown in part (b1) and a second three-dimensional projection data subset represented by solid lines shown in part (b2), wherein part (b1) is located at third positions in the channel direction of part (a), part (b2) is located at fourth positions in the channel direction of part (a), the third positions and the fourth positions alternate in the channel direction, and therefore, the multiplication factor in the channel direction of part (b1) and part (b2) is reduced to 0.5 times. Although the splits shown in the figure are equally spaced, in other embodiments, unequally spaced splits may also be used. For example, a smaller interval split is used at the center of the image, a larger interval split is used at the edge of the image, and so on.

With continued reference to FIG. 11, similar to the processing procedure of FIG. 10, the first projection data subset shown in part (b1) is interpolated to obtain the first interpolated data subset, i.e., the interpolated part. Therefore, the first interpolated data subset and the second three-dimensional projection data subset in part (b2) may form a projection data pair.

Similarly, the second three-dimensional projection data subset shown in part (b2) may be interpolated to obtain the second interpolated data subset, i.e., the interpolated part. Therefore, the second interpolated data subset and the first three-dimensional projection data subset in part (b1) may form another projection data pair.

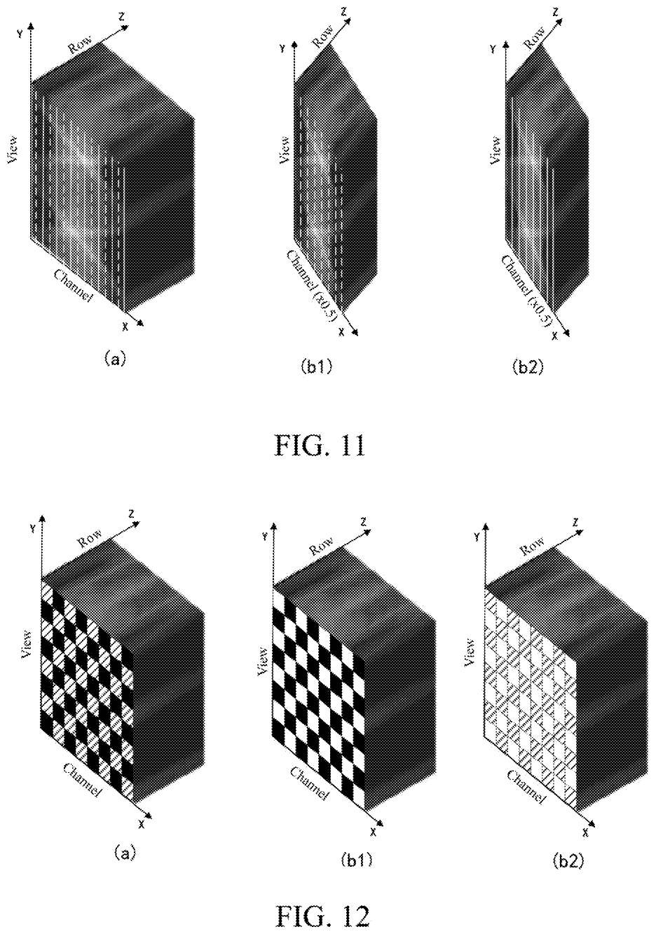

In another embodiment, the first three-dimensional projection data subset and the second three-dimensional projection data subset may be obtained by alternately splitting the raw three-dimensional projection dataset simultaneously in the view direction and the channel direction. FIG. 12 shows a schematic diagram of splitting a raw three-dimensional projection dataset simultaneously in a view direction and a channel direction according to yet another embodiment of the present disclosure. Part (a) shows the raw three-dimensional projection dataset. The raw three-dimensional projection dataset is split alternately in the view direction and the channel direction to obtain a first three-dimensional projection data subset represented by black squares shown in part (b1) and a second three-dimensional projection data subset represented by slash squares shown in part (b2), wherein white squares represent no data, part (b1) is located at first positions in the view direction and third positions in the channel direction of part (a), part (b2) is located at second positions in the view direction and fourth positions in the channel direction of part (a), the first positions and the second positions alternate in the view direction, and the third positions and the fourth positions alternate in the channel direction. It should be understood that although FIG. 12 uses the terms of first position, second position, third position, and fourth position, these positions may be the same as or different from the positions in FIGS. 10 and 11. Although the splits shown in the figure are equally spaced, in other embodiments, unequally spaced splits may also be used. For example, a smaller interval split is used at the center of the image, a larger interval split is used at the edge of the image, and so on.

With continued reference to FIG. 12, similar to the processing procedures of FIG. 10 and FIG. 11, the first three-dimensional projection data subset shown in part (b1) is interpolated to obtain the first interpolated data subset, i.e., the interpolated part. Therefore, the first interpolated data subset and the second three-dimensional projection data subset in part (b2) may form a projection data pair.

Similarly, the second three-dimensional projection data subset shown in part (b2) may be interpolated to obtain the second interpolated data subset, i.e., the interpolated part. Therefore, the second interpolated data subset and the first three-dimensional projection data subset in part (b1) may form another projection data pair.

Referring again to FIG. 9, at block 906, the first three-dimensional projection data subset and the second interpolated data subset obtained in block 904 are inputted as a first data pair into a denoising neural network to generate a first denoised data subset, and the second three-dimensional projection data subset and the first interpolated data subset are inputted as a second data pair into the denoising neural network to generate a second denoised data subset.

When the denoising neural network is trained, the first three-dimensional projection data subset may be used as a network input, the second interpolated data subset may be used as a ground truth, the second three-dimensional projection data subset may be used as a network input, and the first interpolated data subset may be used as a ground truth. Losses of the two sets of projection data pairs may be combined to optimize a training result and improve overall denoising performance of the model. Examples of denoising networks include, but are not limited to, Noise2Noise (N2N), Noise2Void (N2V), a denoising convolutional neural network (DnCNN), a denoising autoencoder (DAE), or the like.

Finally, at block 908, the first denoised data subset and the second denoised data subset are synthesized to generate a denoised raw three-dimensional projection dataset. The denoised raw three-dimensional projection dataset may then undergo subsequent decomposition at block 404 described above with reference to FIG. 4.

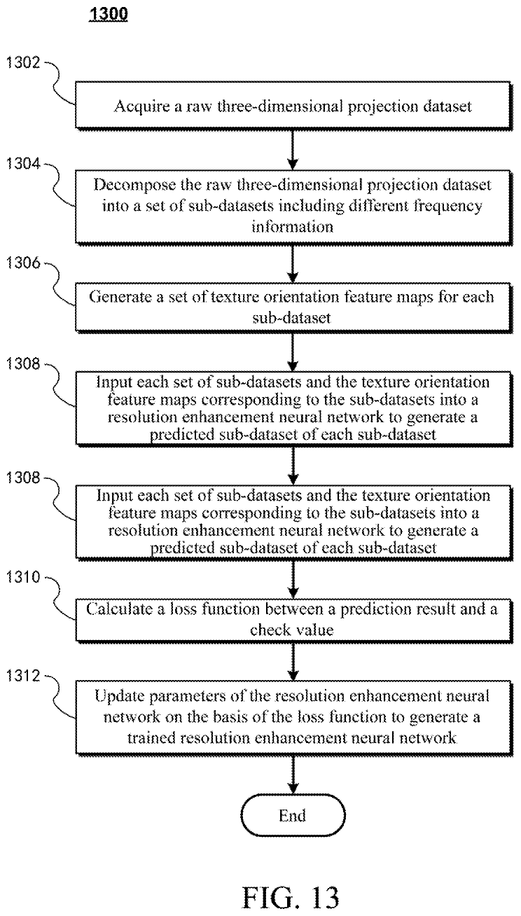

FIG. 13 shows a flowchart of an example method 1300 for training a resolution enhancement neural network according to an embodiment of the present disclosure. The resolution enhancement neural network may be used to perform resolution enhancement on the decomposed sub-datasets in the method described with reference to FIG. 4, and inputs of the resolution enhancement neural network include the sub-datasets and the texture orientation feature maps corresponding to the sub-datasets.

At block 1302, similar to block 402 described with reference to FIG. 4, a raw three-dimensional projection dataset is acquired. The dataset may be generated by a medical imaging system. At block 1304, similar to block 404 described with reference to FIG. 4, the raw three-dimensional projection dataset is decomposed into a set of sub-datasets including different frequency information. At block 1306, similar to block 406 described with reference to FIG. 4, texture orientation feature extraction is executed on the set of sub-datasets obtained at block 1304 to generate a set of texture orientation feature maps for each sub-dataset. At block 1308, each set of sub-datasets and the texture orientation feature maps corresponding to the sub-datasets are inputted into the resolution enhancement neural network to generate a predicted sub-dataset of each sub-dataset. Ideally, the predicted sub-dataset has a higher resolution than the input sub-dataset.

To optimize a prediction result, at block 1310, a loss function between the prediction result and a check value is calculated. The check value is the ground truth, for example, the check value may be a high-resolution three-dimensional projection dataset obtained for a same region of interest of a same subject under examination by another high-resolution imaging means. In an embodiment, the loss function includes at least one of the following: a mean absolute error loss function between the prediction result and the check value; a mean absolute error loss function between the predicted sub-datasets of all sub-datasets and corresponding sub-datasets of the check value; and a mean absolute error loss function between a texture orientation feature map of the prediction result and a texture orientation feature map of the check value.

The mean absolute error loss function Loss_{MAE} may be used to calculate losses pixel by pixel, and performs calculation by using the following Equation 2:

$${Loss}_{MAE} = {I}_{predict} - {I}_{gt} \qquad Equation 2$$

wherein I_{predict} represents a value of a prediction result of a pixel, and I_{gt} represents a ground truth of the pixel. By using the loss function, the model can gradually adjust period parameters to minimize a difference between the prediction result and the check value.

The corresponding sub-datasets of the check value may be generated by executing the decomposition process described with respect to blocks 404 and 1304 on the check value. The texture orientation feature map of the prediction result may be generated by executing the texture orientation feature extraction process described with respect to blocks 406 and 1306 on the prediction result. The texture orientation feature map of the check value may also be generated by executing the texture orientation feature extraction process described with respect to blocks 404 and 1304 on the check value.

Finally, at block 1312, the parameters of the resolution enhancement neural network are updated on the basis of the loss function to generate a trained resolution enhancement neural network. In some embodiments, the loss functions described above may be used in combination to improve an optimization result of the resolution enhancement neural network. In this way, the model can find an optimal balance between different loss functions, thereby improving overall performance.

Additionally, the present disclosure further provides a medical imaging system, including: a scanning device, configured to acquire a raw three-dimensional projection dataset of a subject under examination; and a processor, configured to execute any one of the methods 400, 900, and 1300.

Additionally, the present disclosure further provides a non-transient computer-readable medium, having instructions stored thereon, wherein the instructions are executable by a processor to implement any one of the methods 400, 900, and 1300.

Additionally, the present disclosure further provides a computer program product, including instructions, wherein the instructions are executable by a processor to implement any one of the methods 400, 900, and 1300.

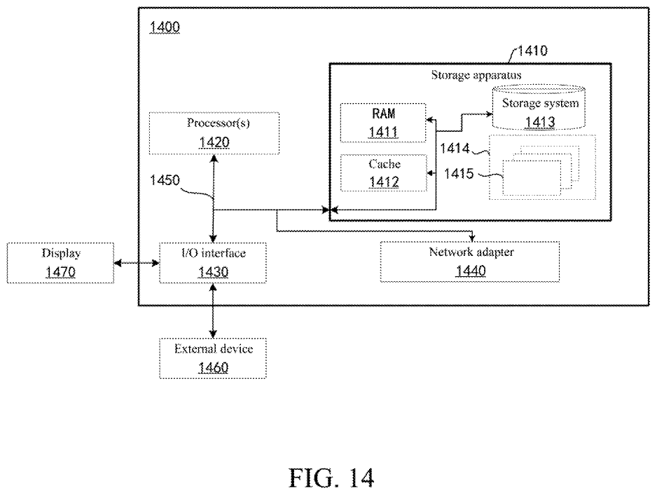

FIG. 14 shows an example block diagram of a computing device 1400 according to an embodiment of the present disclosure. The computing device 1400 may be implemented as an example of the computing device 216 shown in FIG. 2. The computing device 1400 includes: one or more processors 1420; and a storage apparatus 1410, configured to store one or more programs, wherein the one or more programs, when executed by the one or more processors 1420, cause the one or more processors 1420 to implement the processes described in the present disclosure. The processor is, for example, a digital signal processor (DSP), a microcontroller, an application-specific integrated circuit (ASIC), or a microprocessor.

The computing device 1400 shown in FIG. 14 is merely an example, and should not impose any limitation on the functions and scope of use of the embodiments of the present disclosure.

As shown in FIG. 14, the computing device 1400 is represented in the form of a general-purpose computing device. Components of the computing device 1400 may include, but are not limited to: one or more processors 1420, a storage apparatus 1410, and a bus 1450 connecting different system components (including the storage apparatus 1410 and the processor 1420).

The bus 1450 represents one or more of several types of bus structures, including a memory bus or a memory controller, a peripheral bus, an accelerated graphics port, a processor, or a local bus using any of a plurality of bus structures. For example, these architectures include, but are not limited to, an industrial standard architecture (ISA) bus, a micro channel architecture (MAC) bus, an enhanced ISA bus, a video electronics standards association (VESA) local bus, and a peripheral component interconnect (PCI) bus.

The computing device 1400 typically includes a plurality of computer system-readable media. These media may be any available media that can be accessed by the computing device 1400, including volatile and non-volatile media as well as removable and non-removable media.

The storage apparatus 1410 may include a computer system-readable medium in the form of a volatile memory, for example, a random access memory (RAM) 1411 and/or a cache memory 1412. The computing device 1400 may further include other removable/non-removable, and volatile/non-volatile computer system storage media. For example only, a storage system 1413 may be configured to read and write a non-removable, non-volatile magnetic medium (which is not shown in FIG. 14, and is generally referred to as a “hard drive”). Although not shown in FIG. 14, a magnetic disk drive for reading and writing a removable non-volatile magnetic disk (such as a “floppy disk”) and an optical disc drive for reading and writing a removable non-volatile optical disc (such as a CD-ROM, a DVD-ROM, or other optical media) may be provided. In these cases, each drive may be connected to the bus 1450 via one or more data medium interfaces. The storage apparatus 1410 may include at least one program product which has a group of program modules (for example, at least one program module) configured to execute the functions of the embodiments of the present disclosure.

A program/utility tool 1414 having a group (at least one) of program modules 1415 may be stored in, for example, the storage apparatus 1410. This program module 1415 includes, but is not limited to, an operating system, one or more application programs, other program modules, and program data, and each of these examples or a certain combination thereof may include implementation of a network environment. The program module 1415 typically executes the function and/or method in any embodiment described in the present disclosure.

The computing device 1400 may also communicate with one or more peripheral devices 1460 (such as a keyboard, a pointing device, and a display 1470), and may also communicate with one or more devices that enable a user to interact with the computing device 1400, and/or communicate with any device (such as a network card and a modem) that enables the computing device 1400 to communicate with one or more other computing devices. Such communication may be performed via an input/output (I/O) interface 1430. Moreover, the computing device 1400 may also communicate with one or more networks (for example, a local area network (LAN), a wide area network (WAN) and/or a public network, for example, the Internet) through a network adapter 1440. As shown in FIG. 14, the network adapter 1440 communicates with other modules of the computing device 1400 via the bus 1450. It should be understood that although not shown in the figure, other hardware and/or software modules may be used in combination with the computing device 1400, including, but not limited to: microcode, device drivers, redundant processing units, external disk drive arrays, RAID systems, tape drives, data backup storage systems, and the like.

The processor 1420, by running programs stored in the storage apparatus 1410, executes various functional applications and data processing, such as implementing the processes described in the present disclosure.

The technique described herein may be implemented with hardware, software, firmware, or any combination thereof, unless specifically described as being implemented in a specific manner. Any features described as modules or components may also be implemented together in an integrated logical device, or separately implemented as discrete but interoperable logical devices. If implemented with software, the technique may be implemented at least in part by a non-transitory processor-readable storage medium that includes instructions, wherein when executed, the instructions execute one or more of the aforementioned methods. The non-transitory processor-readable data storage medium may form part of a computer program product that may include an encapsulation material. Program code may be implemented in a high-level procedural programming language or an object-oriented programming language so as to communicate with a processing system. If desired, the program code may also be implemented in an assembly language or a machine language. In fact, the mechanisms described herein are not limited to the scope of any particular programming language. In any case, the language may be a compiled language or an interpreted language.

One or more aspects of at least some embodiments may be implemented by representative instructions that are stored in a machine-readable medium and represent various logic in a processor, wherein when read by a machine, the representative instructions cause the machine to manufacture the logic for executing the technique described herein.

Such machine-readable storage media may include, but are not limited to, a non-transitory tangible arrangement of an article manufactured or formed by a machine or device, including storage media, such as: a hard disk; any other types of disk, including a floppy disk, an optical disk, a compact disk read-only memory (CD-ROM), compact disk rewritable (CD-RW), and a magneto-optical disk; a semiconductor device such as a read-only memory (ROM), a random access memory (RAM) such as a dynamic random access memory (DRAM) and a static random access memory (SRAM), an erasable programmable read-only memory (EPROM), a flash memory, and an electrically erasable programmable read-only memory (EEPROM); a phase change memory (PCM); a magnetic or optical card; or any other type of medium suitable for storing electronic instructions.

Instructions may further be sent or received by means of a network interface device that uses any of a number of transport protocols (for example, Frame Relay, Internet Protocol (IP), Transfer Control Protocol (TCP), User Datagram Protocol (UDP), and Hypertext Transfer Protocol (HTTP)) and through a communication network using a transmission medium.

An example communication network may include a local area network (LAN), a wide area network (WAN), a packet data network (for example, the Internet), a mobile phone network (for example, a cellular network), a plain old telephone service (POTS) network, and a wireless data network (for example, Institute of Electrical and Electronics Engineers (IEEE) 802.11 standards referred to as Wi-Fi®, and IEEE 802.19 standards referred to as WiMax®), IEEE 802.15.4 standards, a peer-to-peer (P2P) network, and the like. In one example, the network interface device may include one or more physical jacks (for example, Ethernet, coaxial, or phone jacks) or one or more antennas for connection to the communication network. In one example, the network interface device may include a plurality of antennas that wirelessly communicate using at least one of single-input multiple-output (SIMO), multiple-input multiple-output (MIMO), and multiple-input single-output (MISO) technology.

The term “transmission medium” should be considered to include any intangible medium capable of storing, encoding, or carrying instructions for execution by a machine, and the “transmission medium” includes digital or analog communication signals or any other intangible medium for facilitating communication of such software.

So far, the method for generating resolution-enhanced medical imaging data and the method for training a resolution enhancement neural network according to the present disclosure have been described, and the medical imaging system, the computer-readable storage medium, and the computer program product that can implement the methods have been further described.

Some exemplary embodiments have been described above. However, it should be understood that various modifications can be made to the exemplary embodiments described above without departing from the spirit and scope of the present invention. For example, an appropriate result can be achieved if the described techniques are executed in a different order and/or if the components of the described system, architecture, device, or circuit are combined in other manners and/or replaced or supplemented with additional components or equivalents thereof, accordingly, the modified other implementations also fall within the scope of protection of the claims.

What is claimed is:

1. A method for generating resolution-enhanced imaging data, comprising:
acquiring a raw three-dimensional projection dataset, the raw three-dimensional projection dataset being generated by an imaging system scanning a subject under examination;
decomposing the raw three-dimensional projection dataset into a set of sub-datasets comprising different frequency information;
executing texture orientation feature extraction on each sub-dataset in the set of sub-datasets to generate a set of texture orientation feature maps for each sub-dataset;
inputting each sub-dataset in the set of sub-datasets and the set of texture orientation feature maps corresponding to the sub-dataset into a resolution enhancement neural network to generate a resolution-enhanced sub-dataset of each sub-dataset, wherein the resolution-enhanced sub-dataset has a higher resolution than the corresponding sub-dataset in the set of sub-datasets; and
synthesizing the resolution-enhanced sub-datasets of all sub-datasets to generate a resolution-enhanced three-dimensional projection dataset corresponding to the raw three-dimensional projection dataset, wherein the resolution-enhanced three-dimensional projection dataset has a higher resolution than the raw three-dimensional projection dataset and is used to reconstruct an image of the subject under examination.

2. The method according to claim 1, wherein the raw three-dimensional projection dataset is acquired by a detector of the imaging system and comprises three dimensions: a row direction, a channel direction, and a view direction, the row direction indicating a direction of the detector in which the subject under examination moves toward or out of the imaging system, the channel direction indicating an extension direction perpendicular to the row direction and along the detector arranged to partially surround the subject under examination, and the view direction indicating angles at which the detector acquires the raw three-dimensional projection dataset at different positions around the subject under examination.

3. The method according to claim 2, wherein the decomposition is executed on a channel-view plane in the raw three-dimensional projection dataset.

4. The method according to claim 3, wherein executing the decomposition comprises: executing at least one wavelet transform on two-dimensional projection data in each channel-view plane in the raw three-dimensional projection dataset by using wavelet basis functions of different frequencies.

5. The method according to claim 4, wherein the synthesis comprises: performing an inverse transform by using wavelet basis functions that are the same as the wavelet basis functions used in the decomposition.

6. The method according to claim 2, further comprising: performing denoising processing on the raw three-dimensional projection dataset before executing the decomposition on the raw three-dimensional projection dataset, wherein
the decomposition is applied to a denoised raw three-dimensional projection dataset.

7. The method according to claim 6, wherein performing denoising processing on the raw three-dimensional projection dataset comprises:
splitting the raw three-dimensional projection dataset alternately in the view direction and/or the row direction to generate a first three-dimensional projection data subset and a second three-dimensional projection data subset;
interpolating the first three-dimensional projection data subset to generate a first interpolated data subset, and interpolating the second three-dimensional projection data subset to generate a second interpolated data subset;
inputting the first three-dimensional projection data subset and the second interpolated data subset as a first data pair into a denoising neural network to generate a first denoised data subset, and inputting the second three-dimensional projection data subset and the first interpolated data subset as a second data pair into the denoising neural network to generate a second denoised data subset; and
synthesizing the first denoised data subset and the second denoised data subset to generate the denoised raw three-dimensional projection dataset.

8. The method according to claim 7, wherein the first three-dimensional projection data subset comprises data blocks at first positions in the view direction, the second three-dimensional projection data subset comprises data blocks at second positions in the view direction, and the first positions and the second positions alternate in the view direction; and/or
the first three-dimensional projection data subset comprises data blocks at third positions in the row direction, the second three-dimensional projection data subset comprises data blocks at fourth positions in the row direction, and the third positions and the fourth positions alternate in the row direction.

9. The method according to claim 1, wherein the imaging system is a computed tomography imaging system, a positron emission tomography-computed tomography imaging system, or a positron emission tomography imaging system.

10. A method for training a resolution enhancement neural network, comprising:
acquiring a raw three-dimensional projection dataset, the raw three-dimensional projection dataset being generated by an imaging system scanning a subject under examination;
decomposing the raw three-dimensional projection dataset into a set of sub-datasets comprising different frequency information;
executing texture orientation feature extraction on each sub-dataset in the set of sub-datasets to generate a set of texture orientation feature maps for each sub-dataset;
inputting each sub-dataset in the set of sub-datasets and the set of texture orientation feature maps corresponding to the sub-dataset into a resolution enhancement neural network to generate a predicted sub-dataset of each sub-dataset;
synthesizing the predicted sub-datasets of all sub-datasets to generate a prediction result;
calculating a loss function between the prediction result and a check value, wherein the check value has a resolution higher than that of the raw three-dimensional projection dataset and is used to reconstruct an image of the subject under examination; and
updating parameters of the resolution enhancement neural network on the basis of the loss function to generate a trained resolution enhancement neural network.

11. The method according to claim 10, wherein the loss function comprises at least one of the following: a mean absolute error loss function between the prediction result and the check value; a mean absolute error loss function between the predicted sub-datasets of all sub-datasets and corresponding sub-datasets of the check value; and a mean absolute error loss function between a texture orientation feature map of the prediction result and a texture orientation feature map of the check value, wherein
the corresponding sub-datasets of the check value are generated by executing the decomposition on the check value, the texture orientation feature map of the prediction result is generated by executing texture orientation feature extraction on the prediction result, and the texture orientation feature map of the check value is generated by executing texture orientation feature extraction on the check value.

12. The method according to claim 10, wherein the raw three-dimensional projection dataset is acquired by a detector of the imaging system and comprises three dimensions: a row direction, a channel direction, and a view direction, the row direction indicating a direction of the detector in which the subject under examination moves toward or out of the imaging system, the channel direction indicating an extension direction perpendicular to the row direction and along the detector arranged to partially surround the subject under examination, and the view direction indicating angles at which the detector acquires the raw three-dimensional projection dataset at different positions around the subject under examination.

13. The method according to claim 12, wherein the decomposition is executed on a channel-view plane in the raw three-dimensional projection dataset.

14. The method according to claim 13, wherein executing the decomposition comprises: executing at least one wavelet transform on two-dimensional projection data in each channel-view plane in the raw three-dimensional projection dataset by using wavelet basis functions of different frequencies.

15. The method according to claim 14, wherein the synthesis comprises: performing an inverse transform by using wavelet basis functions that are the same as the wavelet basis functions used in the decomposition.

16. The method according to claim 12, further comprising: performing denoising processing on the raw three-dimensional projection dataset before executing the decomposition on the raw three-dimensional projection dataset, wherein
the decomposition is applied to a denoised raw three-dimensional projection dataset.

17. The method according to claim 16, wherein performing denoising processing on the raw three-dimensional projection dataset comprises:
splitting the raw three-dimensional projection dataset alternately in the view direction and/or the row direction to generate a first three-dimensional projection data subset and a second three-dimensional projection data subset;
interpolating the first three-dimensional projection data subset to generate a first interpolated data subset, and interpolating the second three-dimensional projection data subset to generate a second interpolated data subset;
inputting the first three-dimensional projection data subset and the second interpolated data subset as a first data pair into a denoising neural network to generate a first denoised data subset, and inputting the second three-dimensional projection data subset and the first interpolated data subset as a second data pair into the denoising neural network to generate a second denoised data subset; and
synthesizing the first denoised data subset and the second denoised data subset to generate the denoised raw three-dimensional projection dataset.

18. The method according to claim 17, wherein the first three-dimensional projection data subset comprises data blocks at first positions in the view direction, the second three-dimensional projection data subset comprises data blocks at second positions in the view direction, and the first positions and the second positions alternate in the view direction; and/or
the first three-dimensional projection data subset comprises data blocks at third positions in the row direction, the second three-dimensional projection data subset comprises data blocks at fourth positions in the row direction, and the third positions and the fourth positions alternate in the row direction.

19. The method according to claim 10, wherein the imaging system is a computed tomography imaging system, a positron emission tomography-computed tomography imaging system, or a positron emission tomography imaging system.
